(19) United States
(12) Patent Application Publication
(10) Pub. No.: US 2010/0313255 A1
(43) Pub. Date: Dec. 9, 2010

(54) Web Browser and Web Page Plug-In Language Translation Method and System

(75) Inventor: Khaled R. Khuda, Altamonte Springs, FL (US)

Correspondence Address: Matthew G. McKinney;Shuffield, Lowman & Wilson, P.A., 1000 Legion Place, Suite 1700, Orlando, FL, 32801, US

(73) Assignee: EXLING, LLC, Altamonte Springs, FL (US)

(21) Appl. No.: 12/792,831

(22) Filed: Jun. 3, 2010

Related U.S. Application Data
(60) Provisional application No. 61/183,756, filed on Jun. 3, 2009.

(51) Int. Cl. G06F 17/28; G06F 15/16; G06F 21/20

(52) U.S. Cl. 726/7; 709/206; 704/2

(57) ABSTRACT

A language translation method and system are disclosed. The system includes a plug-in to interface with a host application, a proxy server, where the plug-in directs the host application to connect to the proxy server, a translation engine on a remote server, and a message in a first language transmitted by a first user to the proxy server as directed by the plug-in, where the message is forwarded to the translation engine to translate the message to a second language and the proxy server transmits a translated message via a community site server to a second user for display. A message in the second language is transmitted by the second user to the proxy server as directed by the plug-in, where the message is forwarded to the translation engine to translate the message and the proxy server transmits the translated message via the community site server to the first user.

### I. CROSS-REFERENCE TO RELATED APPLICATIONS

This application claims the benefit of U.S. Provisional Application No. 61/183,756 filed Jun. 3, 2009. The disclosure of the provisional application is incorporated herein by reference.

### II. FIELD

The present disclosure is generally related to a web browser and web page plug-in language translation method and system.

### III. DESCRIPTION OF RELATED ART

There is a growing need for a web browser and web page plug-in that can help access real-time interactive or live translations from text- to-text. Currently available methods allow for existing page translations or translations by form. However, interactive content on business and other entertainment sites require either interaction or live or streaming content translation from language to language. Accordingly, there is a need for a browser or website to include a plug-in service to pull user language preferences and manage these streaming or interactive contents into the language of each user automatically.

However, in view of the prior art at the time the present invention was made, it was not obvious to those of ordinary skill in the pertinent art how the identified needs could be fulfilled. It is, therefore, to the effective resolution of the aforementioned problems and shortcomings of the prior art that the present invention is directed.

### IV. SUMMARY

In a particular embodiment, a plug-in language translation system is disclosed. The system includes a plug-in to interface with a host application, a proxy server, where the plug-in directs the host application to connect to the proxy server, a translation engine on a remote server, and a message in a first language transmitted by a first user to the proxy server as directed by the plug-in, where the message is forwarded to the translation engine to translate the message to a second language and the proxy server transmits a translated message via a community site server to a second user for display. In addition, the plug-in language translation system may include that a message in the second language is transmitted by the second user to the proxy server as directed by the plug-in, where the message is forwarded to the translation engine to translate the message to the first language and the proxy server transmits the translated message via the community site server to the first user for display. A first user profile may be used to identify a preference of the first user for the first language and the first user profile may be stored by a database. A second user profile may be used to identify a preference for the second language. The proxy server may be used to transmit the translated message to a plurality of users. The plug-in may be activated by a user login and password and the plug-in may be configured to accept a cookie to identify the language preference of the user. The system may be configured to translate interactive or streaming text and include a web site for the user to log into the system.

In another particular embodiment, a web browser language translation system is disclosed. The system includes a web browser to interface with a host application, a proxy server, where the web browser directs the host application to connect to the proxy server. In addition, a translation engine is on a remote server, and a message in a first language transmitted by a first user to the proxy server as directed by the web browser, where the message is forwarded to the translation engine to translate the message to a second language and the proxy server transmits a translated message via a community site server to a second user for display. A message in the second language may be transmitted by the second user to the proxy server as directed by the web browser, where the message is forwarded to the translation engine to translate the message to the first language and the proxy server transmits the translated message via the community site server to the first user for display. A first user profile is used to identify a preference of the first user for the first language and a second user profile is used to identify a preference for the second language. The proxy server may transmit the translated message to a plurality of users. The first user profile may be activated by a user login and password and the first user profile may be stored by a database.

In another particular embodiment, a language translation method is disclosed. The method includes accessing a proxy server by a first user in a first language, transmitting a message in the first language to a second user via the proxy server, forwarding the message to a translation engine to translate the message to a second language of the second user, and transmitting a translated message back via a community site server to the second user for display. The language translation method may also include using a plug-in or web browser extension to access the proxy server and to forward the message to the translation engine for translation. In addition, the method may include retrieving the second language of the second user from a database and using the server to transmit the translated message via the community site server to the second user for display.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative embodiment of a web browser and web page plug-in translation method and system;

FIG. 2 is an operational flow diagram of a particular illustrative embodiment of a web browser and web page plug-in translation method and system;

FIG. 3 is a flow diagram depicting an example of the web browser and plug-in translation method and system in operation;

FIG. 4 is a flow diagram of a particular illustrative embodiment of web browser and plug-in translation method; and

FIG. 5 is a block diagram of an illustrative embodiment of a general computer system.

### VI. DETAILED DESCRIPTION

A web browser and web page plug-in language translation method and system are disclosed. The system includes a browser or website plug-in to communicate with a proxy server for translation purposes. The proxy server may be accessed online through the Internet. The proxy server stores user preference settings, where the preference settings are identified by a user profile and a user password-protected login. Once a user is logged-in to the proxy server, each individual site or browser uses the settings of the profile when engaged in interactive communication services. The system sends requests to the proxy server to seek the content, obtain and translate the text, and then deliver the translated text to the browser or host application. In an embedded chat forum or interactive text environment, a plug-in would route all outbound text via the online server to the destination. All inbound interactive or streaming text using the system is routed through the system back to the computer. In operation, all text is communicated and received in the recipient's native language preference set by the login on the plug-in. The system may be used for text translation of all interactive communication types and live streaming feeds.

As explained above, a server provides the Internet-based translation. More than one computing device may access the Internet with each device having an Internet web browser. Each web browser will either have a plug-in service or an individual website providing the service that allows logging in to an account on the service. Each account would have at least settings for the login, password, and language preference. Other settings in the profile can be added for additional functionalities. The browser or site for each user will initiate communication when a session is started that requires the service. On a successful session start, the plug-in will accept a cookie or other type of setting/configuration file from the service of the latest settings for each user (source and destination or destinations—multiple). The source computer will stamp the data to be translated, the language settings of the source, the destination profile ID names, and their settings to the communication. The service running on the server will use this information to translate the language for any inequality in settings such that the recipient receives the information under the language settings of the recipient's profile. Replies from the recipient will repeat such that this computer becomes the source. Login IDs can be transferrable between computing device by ID name (login/password). Login profiles will be stored in a database on the service providing server. These services can include, but are not limited to, potential site-embedded chatting for technical support, streams of live text in a page embedded-video, or other instant multi-user communications originating from a web-page embedded feature and not a separate program.

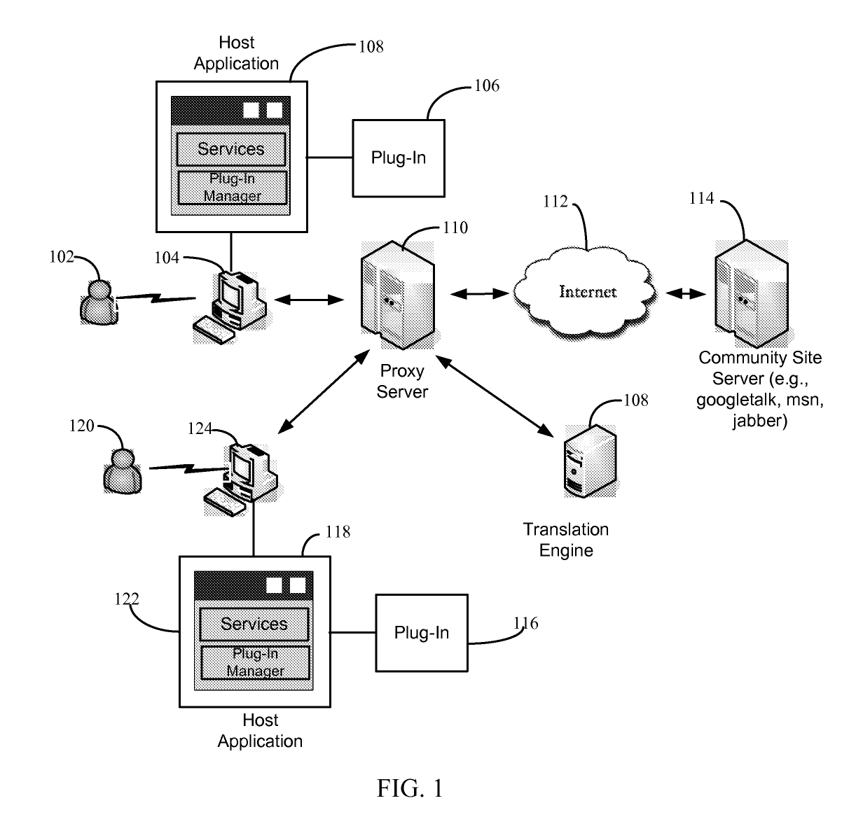

Referring now to FIG. 1, a first user 102 is identified. The first user 102 may use a personal computer 104 or other communication device to open an interactive communication host application 108 to begin a communication session (e.g., instant messaging). An Internet connection 112 and proxy server 110 are configured to be verified so that at least one other user may be invited/accepted into a session by an online profile ID. A plug-in 106 is configured to interface with the host application 108. The plug-in 106 directs the host application to connect to a community site server 114 through the proxy server 110. The session is then ready to be initiated and a port of the online proxy server 110 is then initiated for the session. The connection is made between the first user 102 to the community site server 114 via the online proxy server 110. The proxy server 110 sends the IP address and number of the port assigned to the first user 102 on the proxy server 110. Thus, the first user 102 is now logged into the session with the community site server 114 via the proxy server 110.

An interactive communication host application 118 on the second user's personal computer 124 or other communication device accesses the second user's language preference, which may be stored locally or on the proxy server 110. A plug-in 116 is configured to interface with the host application 118. The plug-in 116 directs the host application 118 to connect to the community site server 114 through the proxy server 110. The Internet connection 112 and proxy server 110 are configured to be verified with a profile ID so that the second user 120 and the first user 102 are in the same session. The connection is made between the second user 120 to the community site server 114 via the online proxy server 110, and the proxy server 110 sends the IP address and number of the port assigned to the second user 120 on the proxy server. The second user 120 is now logged into the session with the community site server 114 via the proxy server 110.

The first user 102 and the second user 120 can now communicate with one another without using the community site server 114 as the IP address and port number assigned for each user on the proxy server 110 is provided to the other and stored within the respective host application 108. For example, the first user 102 enters a text message using the host application 108 and sends the message to the second user 120. The proxy server 110 automatically translates the language of the text from the first user 102 into the language preference of the second user 120 using a remote translation engine 108, then forwards the translated message to the second user 120 using the second user's connection information. Similarly, the proxy server 110 automatically translates the language of the text from the second user 120 into the language preference of the first user 102 using the remote translation engine 108, when the second user 120 sends a text message to the first user 102.

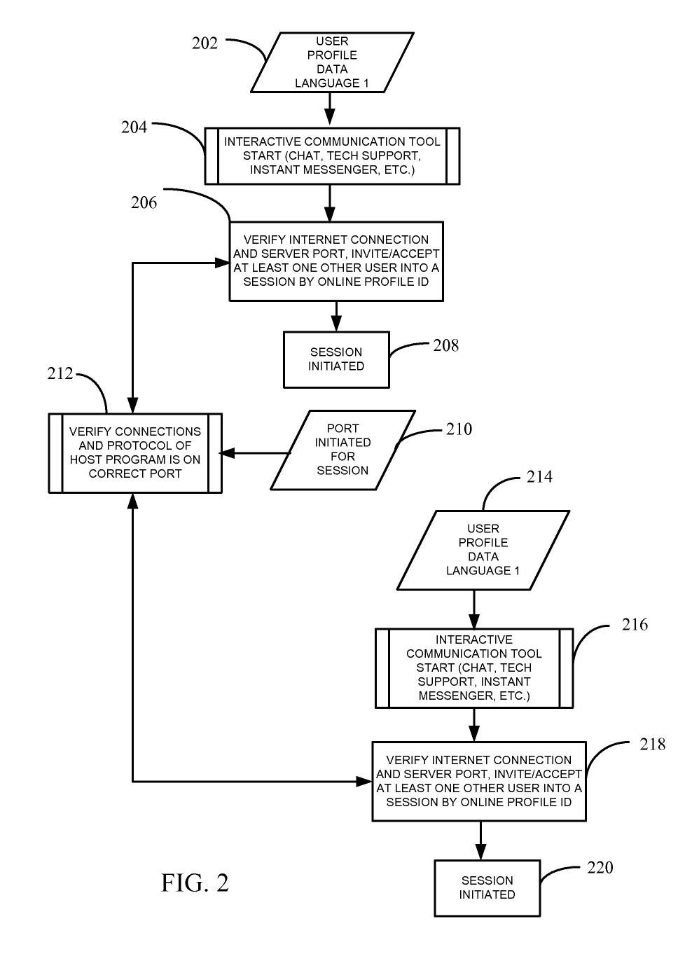

Referring now to FIG. 2, a first user profile data language 202 is identified. An interactive communication tool 204 accesses the user profile data language 202. An Internet connection and server port is configured to be verified at 206 so that at least one other user may be invited/accepted into a session by an online profile ID. The session is then ready to be initiated at 208. A port of an online proxy server is then initiated for the session, at 210. Moving to 212, the connection is made between the user and the online proxy server, which may verify that the connections and protocol of the host program is on a correct port. Continuing to 214, a second user profile data language 214 is identified. An interactive communication tool 216 accesses the user profile data language 216. The Internet connection and server port is configured to be verified at 218 with an online profile ID so that the second user and the first user are in the same session. The session is then initiated at 220. The proxy server 212 automatically translates the language of the text from the first user into the language of the second user, when the first user sends a text message to the second user. Similarly, the proxy server 212 automatically translates the language of the text from the second user into the language of the first user, when the second user sends a text message to the first user.

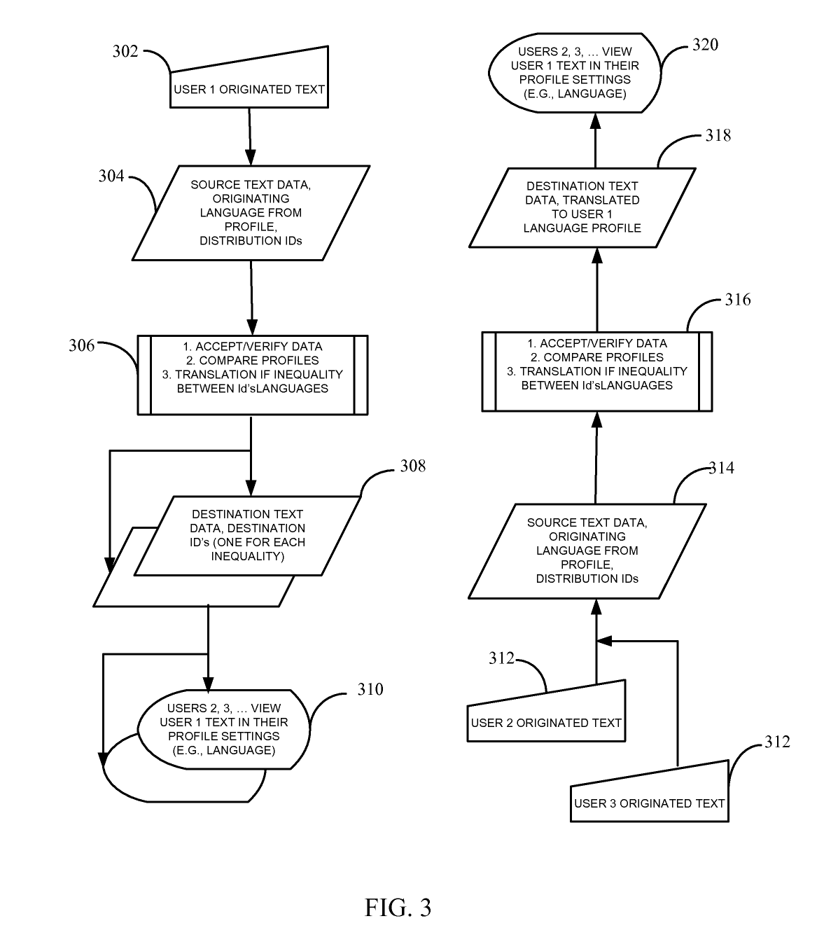

In operation, the first user originates some text as shown in FIG. 3. The source text data 304 is in the originating language based on the user profile and distribution Ids. At 306, the online proxy translation server accepts/verifies the data, compares profiles, and performs a translation if there is an inequality between the IDs language. The first user may send text to more than one other user (second user, third user, fourth user, etc . . . ) so that there may be a destination ID for each inequality. The destination text data 308 is then sent to the intended user where each recipient (second user, third user, . . . ) of the first user's text views the text in their own respective profile setting and language 310. The second user (or third user, fourth user, . . . ) may reply to the first user and originate text in the second user's language 312. Next, the source text data in the source language from the source user profile distribution Ids is transmitted to the online proxy server at 314. The online proxy translation server, at 316, accepts/verifies the data, compares profiles, and performs a translation if there is an inequality between the IDs language. The destination text data 318 is then sent to the first user and the first user views the text in the first user's profile setting and language 320.

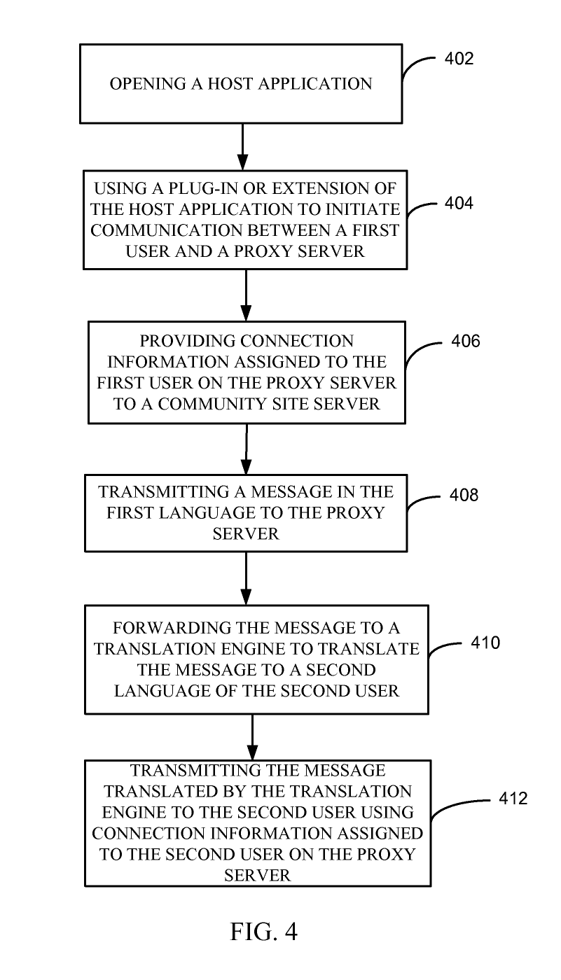

Referring now to FIG. 4, a language translation method is disclosed. At 402, a host application is opened on the first user's personal computer or other communication device. A plug-in or extension of the host application (e.g., client or web browser) is used to initiate communication between a first user and a proxy server, at 404. Continuing to 406, connection information assigned to the first user on the proxy server is provided to a community site server (e.g., googletalk, msn, jabber). A message is transmitted in the first language, at 408, to the proxy server. The message is forwarded, at 410, by the proxy server to a translation engine to translate the message to a second language of the second user. The message translated by the translation engine, which may be on a remote server, is transmitted, at 412, to the second user by the proxy server using connection information assigned to the second user on the proxy server.

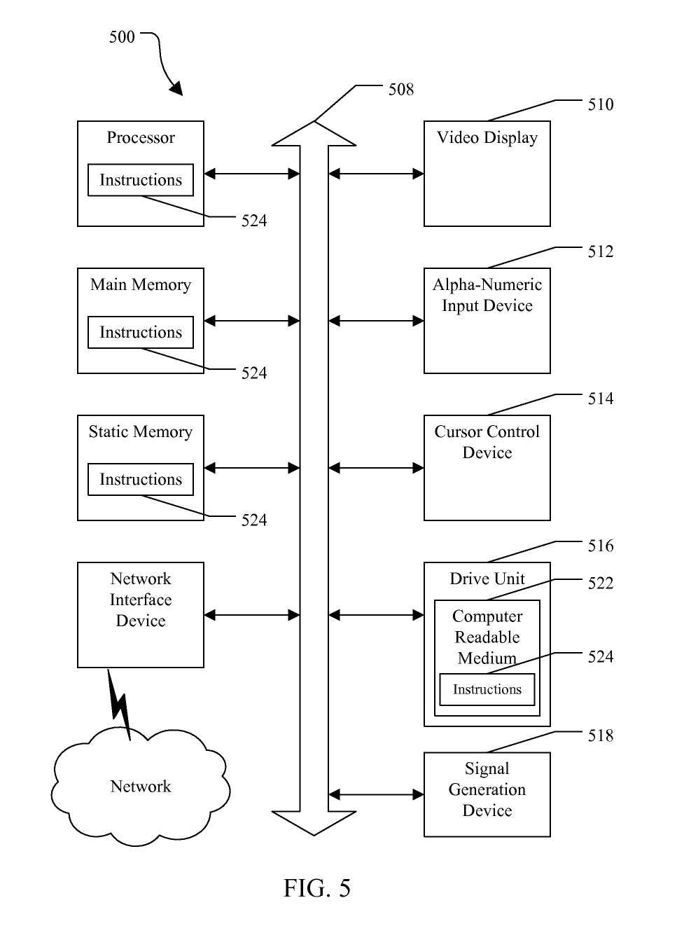

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500, or any portion thereof, may operate as a standalone device or may be connected, e.g., using a network, to other computer systems or peripheral device.

In a networked deployment, the computer system may operate in the capacity of a server, such as a video server or application server, or a transmitter. The computer system 500 can also be implemented as or incorporated into various devices, such as a personal computer (PC), a tablet PC, a media device (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics-processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), an organic light emitting diode (OLED), a flat panel display, a solid-state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal, so that a device connected to a network can communicate voice, video or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying out a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered an equivalent to a tangible storage medium. Accordingly, the disclosure is considered to include any one or more of a computer-readable medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal including computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.52(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A plug-in language translation system, the system comprising:
a plug-in to interface with a host application;
a proxy server, wherein the plug-in directs the host application to connect to the proxy server;
a translation engine on a remote server; and
a message in a first language transmitted by a first user to the proxy server as directed by the plug-in, wherein the message is forwarded to the translation engine to translate the message to a second language and the proxy server transmits a translated message via a community site server to second user for display.

2. The plug-in language translation system of claim 1, wherein a message in the second language is transmitted by the second user to the proxy server as directed by the plug-in, wherein the message is forwarded to the translation engine to translate the message to the first language and the proxy server transmits the translated message via the community site server to the first user for display.

3. The plug-in language translation system of claim 2, further comprising a first user profile to identify a preference of the first user for the first language.

4. The plug-in language translation system of claim 3, further comprising a second user profile to identify a preference for the second language.

5. The plug-in language translation system of claim 4, wherein the proxy server transmits the translated message to a plurality of users.

6. The plug-in language translation system of claim 5, wherein the plug-in is activated by a user login and password.

7. The plug-in language translation system of claim 6, wherein the first user profile is stored by a database.

8. The plug-in language translation system of claim 7, wherein the plug-in is configured to accept a cookie to identify the language preference of the user.

9. The plug-in language translation system of claim 8, wherein the system is configured to translate interactive or streaming text.

10. The plug-in language translation system of claim 9, further comprising a web site for the user to log into the system.

11. A web browser language translation system, the system comprising:
a web browser to interface with a host application;
a proxy server, wherein the web browser directs the host application to connect to the proxy server;
a translation engine on a remote server; and
a message in a first language transmitted by a first user to the proxy server as directed by the web browser, wherein the message is forwarded to the translation engine to translate the message to a second language and the proxy server transmits a translated message via a community site server to a second user for display.

12. The web browser language translation system of claim 11, wherein a message in the second language is transmitted by the second user to the proxy server as directed by the web browser, wherein the message is forwarded to the translation engine to translate the message to the first language and the proxy server transmits the translated message via the community site server to the first user for display.

13. The web browser language translation system of claim 12, further comprising a first user profile to identify a preference of the first user for the first language.

14. The web browser language translation system of claim 13, further comprising a second user profile to identify a preference for the second language.

15. The web browser language translation system of claim 14, wherein the proxy server transmits the translated message via the community site server to a plurality of users.

16. The web browser language translation system of claim 15, wherein the first user profile is activated by a user login and password.

17. The plug-in language translation system of claim 6, wherein the first user profile is stored by a database.

18. A language translation method, the method comprising:
accessing a proxy server by a first user in a first language;
transmitting a message in the first language to a second user via the proxy server;
forwarding the message to a translation engine to translate the message to a second language of the second user; and
transmitting a translated message via a community site server back to the second user for display.

19. The language translation method of claim 18, further comprising using a plug-in or web browser extension to access the proxy server and to forward the message to the translation engine for translation.

20. The language translation method of claim 19, further comprising accepting a cookie to identify the language preference of a user.
